(19) United States
(12) Patent Application Publication
(10) Pub. No.: US 2026/0169164 A1
(43) Pub. Date: Jun. 18, 2026

(54) LIGHTING DEVICE FOR A TIME-OF-FLIGHT CAMERA SYSTEM

(71) Applicant: ifm electronic gmbh, Essen (DE)

(72) Inventors: Christian Brey, Friedrichshafen (DE); Peter Möhrle, Horgenzell (DE)

(73) Assignee: ifm electronic gmbh, Essen (DE)

(21) Appl. No.: 19/419,657

(22) Filed: Dec. 15, 2025

(30) Foreign Application Priority Data
Dec. 17, 2024 (DE) 102024138219.8

(51) Int. Cl. G01S 17/36; G01S 7/484; H02H 9/02

(52) U.S. Cl. CPC G01S 17/36; G01S 7/484; H02H 9/025

(57) ABSTRACT

Lighting device (1) for a time-of-flight camera system (41), with a light transmitter unit (3) comprising at least one lighting path (7a, 7b) with at least one light source (5), and with at least one power source (8, 8a, 8b) for providing an input current Iᵢₙ(t) at the at least one lighting path (7a, 7b), and with a modulator (11) for modulating an output current Iₒᵤₜ(t) flowing through the light sources (5), and with at least one first safety circuit (31a, 31b) which is arranged at an output of at least one lighting path (7a, 7b) and is designed to detect the output current Iₒᵤₜ(t) flowing through the light sources (5) of the at least one lighting path (7a, 7b). The first safety circuit (31a, 31b) comprises at least three circuit parts (55a-1, 55a-2, 55a-3), wherein
a first circuit part (55a-1) is designed to detect a first mean current I_{avg,1} and to compare it with a first current threshold I_{max,1}, wherein the first mean current I_{avg,1} corresponds to the output current Iₒᵤₜ₍ₜ₎ averaged over a first time interval Δt1,
a second circuit part (55a-2) is designed to detect a second mean current I_{avg,2} and to compare it with a second current threshold I_{max,2}, wherein the second mean current I_{avg,2} corresponds to the output current Iₒᵤₜ(t) averaged over a second time interval Δt2, and
a third circuit part (55a-3) is designed to detect a third mean current I_{avg,3} and to compare it with a third current threshold I_{max,3}, wherein the third mean current I_{avg,3} corresponds to the output current Iₒᵤₜ(t) averaged over a third time interval Δt3; wherein Δt3>Δt2>Δt1; and
   wherein the first safety circuit (7a, 7b) is designed to switch off the output current Iₒᵤₜ₍ₜ₎ through the light sources (5) when at least one of the current thresholds I_{max,1}, I_{max,2}, or I_{max,3} is exceeded by the respective mean output current I_{avg,1}, I_{avg,2}, or I_{avg,3}.

The invention relates to a lighting device for a time-of-flight camera system as is used, for example, in process automation for distance measurement or object recognition.

The lighting device can be used in particular in a time-of-flight (TOF) camera system, which can obtain time-of-flight information from the phase shift of radiation emitted by a light transmitter unit and radiation received by a photodetector. Time-of-flight (TOF) cameras, especially PMD time-of-flight cameras with photomixing detectors (PMD), are suitable, as described, among others, in applications EP 1 777 747B1, U.S. Pat. No. 6,587,186B2, and also DE 197 04 496C2. The PMD time-of-flight camera allows, in particular, a flexible arrangement of the light transmitter unit and the photodetector, which can be arranged both in one housing and separately.

To determine a distance from the light travel time information via the phase shift, the phase position of a modulation signal and the phase position of the radiation detected by the photodetector are usually compared.

Lighting devices for a time-of-flight camera system can include one or more light transmitter units with multiple light sources-for example with one or more laser diodes, lasers, or light-emitting diodes (LED's). Surface emitters (VCSEL's, vertical-cavity surface-emitting lasers) can be used as laser diodes, for example.

If several light sources are provided, the problem often arises of controlling them synchronously to emit light, so that the resulting transmitted light from all light sources has a defined and approximately the same phase. Due to limited installation space, it is often necessary to arrange the light sources on a control circuit, to which the modulation signal is applied via comparatively long electrical signal paths. For example, the parameters can be defined by a lens of the time-of-flight camera. It is often the case that a circuit board on which the control circuit is arranged has a recess, wherein the lens is guided through the recess. Due to the resulting different time delays with which the modulation signal reaches the respective light sources, a phase difference arises between the transmitted light of the individual light sources. For example, if a large number of light sources are connected in series, the time delay between the first and the last light sources in the signal chain can already be large enough to cause a noticeable and undesirable phase difference of the transmitted light. Especially when individual light sources or individual light source arrays are shaded by an obstruction, the mean phase can change and thus lead to inaccuracies in the light time-of-flight measurement.

Another problem arises from the design of typical driver circuits, which, for example, have a MOSFET switch to control the light source: If several parallel drivers are used, the gate drivers for switching the MOSFET's can have different signal time-of-flight delays, which can result in disturbing phase differences even with light sources operated in parallel. Furthermore, the internal switching times of the MOSFET switches in such driver circuits can vary.

The lighting devices of time-of-flight camera systems often have to meet strict eye safety requirements. In particular, it must be ensured that the radiation power of the light sources does not exceed a predetermined threshold. Typically, the emitted radiation power is monitored by means of a so-called monitor diode, which is integrated into the light transmitter unit. However, if no monitor diode or similar optical reference device is available, the radiation power of the light transmitter unit must be monitored in another way.

From DE 10 2017 207 957A1 , a safety circuit for a modulated, switchable light source is known, with a current breaker arranged in the current path of the light source and designed such that, starting from a shutdown signal applied to an input of the current breaker, the current supply to the light source is interrupted, with a first tripping circuit for providing a shutdown signal starting from an exceedance of a maximum current, and with a second tripping circuit for providing a shutdown signal starting from an exceedance of a maximum mean current.

DE 10 2010 001 113 A1 discloses a lighting system for a time-of-flight camera, with a light source consisting of one or more light-emitting diodes (LED's) which can be connected in series or in parallel to form an LED array.

The object of the invention is to provide a lighting device that requires little installation space, meets typical requirements for eye safety, and can switch off the light sources when excessive radiation energy is emitted.

The object is achieved by a lighting device according to claim 1 and a method for operating a time-of-flight camera according to claim 11. Advantageous embodiments of the invention, as well as a time-of-flight camera with a lighting device according to the invention, are specified in the dependent claims.

Advantageous is a lighting device for a time-of-flight camera system, with a light transmitter unit comprising at least one lighting path with at least one light source, and with at least one power source for providing an input current Iᵢₙ(t) at the at least one lighting path and with a modulator for modulating an output current Iₒᵤₜ(t) flowing through the light sources to control the light sources, as well as

with at least one first safety circuit, which is arranged at an output of at least one lighting path and is designed to detect the output current Iₒᵤₜ(t) flowing through the light sources of the at least one lighting path, wherein
the safety circuit comprises at least three circuit parts, wherein
a first circuit part is designed to detect a first mean current I_{avg,1} and to compare it with a first current threshold I_{max,1}, wherein the first mean current I_{avg,1} corresponds to the output current Iₒᵤₜ(t) averaged over a first time interval Δt1,
a second circuit part is designed to detect a second mean current I_{avg,2} and to compare it with a second current threshold I_{max,2}, wherein the second mean current I_{avg,2} corresponds to the output current Iₒᵤₜ(t) averaged over a second time interval Δt2, and
a third circuit part is designed to detect a third mean current I_{avg,3} and to compare it with a third current threshold I_{max,3}, wherein the third mean current I_{avg,3} corresponds to the output current Iₒᵤₜ(t) averaged over a third time interval Δt3; wherein Δt3>Δt2>Δt1; and wherein
the first safety circuit is designed to switch off the output current Iₒᵤₜ(t) through the light sources when at least one of the current thresholds I_{max, 1}, I_{max, 2}, or I_{max,3} is exceeded by the respective mean output current I_{avg,1}, I_{avg,2}, or I_{avg,3}.

This allows the current flowing through the light sources, and thus the transmitted light power or radiation energy, to be monitored, ensuring eye safety. Because the first safety circuit detects the output current Iₒᵤₜ(t) at the output of the at least one lighting path, it can be ensured that the detected mean currents I_{avg,1}, I_{avg,2}, and I_{avg,3} in each case are directly proportional to the radiation energy emitted by the light sources. In particular, current fed back through a driver circuit can also be detected. Furthermore, the safety circuit can prevent backfeeding into the light sources.

Switching off the output current Iₒᵤₜ(t) can be achieved in particular by disconnecting the light sources from the power source(s) and/or by switching off the power source(s) themselves. The lighting device includes, for example, at least one switch by means of which the light sources can be disconnected from the at least one power source. The at least one switch can be switched in particular by the at least one first safety circuit. The switch(es) can, for example, be designed as semiconductor switches. In particular, it may be provided that the semiconductor switches be designed as MOSFET switches. The at least one first safety circuit can then control a gate terminal of the MOSFET switch, so that the light sources can be disconnected from the power source by switching the MOSFET switch.

For distance measurement using a time-of-flight camera, for example, several phase measurements can be carried out during the time interval Δt1. The lighting device can be operated with a pulsed current I(t) (modulation with frequency f1). For phase measurement, the output current Iₒᵤₜ(t) flowing through the light sources can now be modulated with a frequency f2. The third circuit part is used to calculate a mean over the time interval Δt3 to detect the third mean value I_{avg,3}. The time interval Δt1 can be chosen so that short-term current peaks can be detected. Thus, peak detection of the output current Iₒᵤₜ(t) is also possible. The time interval Δt3 can, for example, be adapted to a time scale of the frequency f1. Similarly, the time interval Δt2 can, for example, be adapted to a time scale of the frequency f2. The time interval Δt1 is, for example, adapted for the detection of short-term current peaks (peak detection).

Preferably, the first circuit part comprises a first low-pass filter and a first voltage comparator, the second circuit part comprises a second low-pass filter and a second voltage comparator, and the third circuit part comprises a third low-pass filter and a third voltage comparator. A first input of the voltage comparators can in each case be connected to the corresponding low-pass filter, while a second voltage input is in each case connected to a reference voltage which provides a respective voltage threshold. A first voltage threshold Uₘₐₓ₁, can therefore be applied at the first voltage comparator, a second voltage threshold Uₘₐₓ₂ at the second voltage comparator, and a third voltage threshold Uₘₐₓ₃ at the third voltage comparator. If it is determined that one of the voltage thresholds Uₘₐₓ₁, Uₘₐₓ₂, or Uₘₐₓ₃ is exceeded, the output current Iₒᵤₜ(t) through the light sources can be switched off.

The first low-pass filter can have a first cutoff frequency f_{G1}, the second low-pass filter can have a second cutoff frequency f_{G2}, and the third low-pass filter can have a third cutoff frequency f_{G3}. Especially preferred is f_{G1}>f_{G2}>f_{G3}. Furthermore, it is preferred that the order of the second low-pass filter be greater than or equal to the order of the first low-pass filter, and/or that the order of the third low-pass filter be greater than or equal to the order of the second low-pass filter. For example, the first low-pass filter is designed as a first-order low-pass filter, and/or the second low-pass filter is designed as a first-or second-order low-pass filter, and/or the third low-pass filter is designed as a second-, third-, or higher-order low-pass filter. This allows for a radiation power threshold E_{S}(t) to be set over a period of time corresponding to the time interval Δt3, which is also sensitive to variations in the output current on smaller time scales.

Furthermore, the lighting device can comprise at least two parallel lighting paths. In particular, the parallel lighting paths can be designed so that they have the same signal times of flight for controlling the light sources. This allows the number of light sources connected in series within a lighting path to be kept low and phase differences of the emitted radiation to be minimized.

In some developments, each of the lighting paths includes at least two light sources connected in series. The advantage is then that the number of light sources is the same for all lighting paths. In some embodiments, each of the lighting paths includes at least two VCSEL's connected in series. One anode of a first VCSEL can then be connected to the driver output and the choke output. The cathode of a second VCSEL can then be connected to ground. Additional VCSEL's can be connected in series between the first VCSEL and the second VCSEL.

Furthermore, it may be advantageous for each of the lighting paths to include at least one balancing resistor. This is particularly advantageous when multiple lighting paths are controlled by a common power source. It is particularly advantageous if each lighting path includes at least two balancing resistors. A first balancing resistor can then be arranged at an input of the light sources, between the light sources and the inductor of the respective lighting path. A second balancing resistor can be placed between one output of the light source and ground. If each lighting path includes two VCSEL's, the first balancing resistor can be connected in series between the choke output and the anode of the first VCSEL, and the second balancing resistor can be connected in series between the cathode of the second VCSEL and ground.

The balancing resistors can each comprise a circuit of several resistors. For example, a parallel circuit of resistors can be implemented in each case, so that the power loss across the balancing resistors is minimized.

A balancing resistor arranged at the output of the light sources also has the advantage that a voltage proportional to the output current Iₒᵤₜ can be provided at an input of the first safety circuit. Thus, a precise measurement of the mean output current I_{out,avg} can also be possible.

In some embodiments of the lighting device, each of the lighting paths may include a second safety circuit, which is designed to monitor the input current Iᵢₙ(t) of the respective lighting path. Furthermore, the second safety circuit can be designed to switch off the current through the lighting paths if the input current Iᵢₙ(t) exceeds an input current threshold I_{in,max}.

Preferably, each of the lighting paths comprises at least one choke circuit with at least one inductor. For example, parasitic inductances of the lighting paths can be compensated for using choke circuits. Furthermore, the inductors of the choke circuits can cause a rapid rise in the edges of the modulated control signal of the light sources.

In some developments, the lighting device includes a driver for controlling the light sources, wherein the driver has a driver output for each of the lighting paths, which is electrically connected to the respective lighting path between the choke circuit and the light sources of the respective lighting path. In particular, a driver output can be provided for each of the lighting paths to control the light sources. The electrical coupling of the respective driver output with the associated lighting path is preferably formed between the choke circuit and the light sources of the respective lighting path. For example, each of the driver outputs can be connected to an output of the choke circuit and an anode of a laser diode or light-emitting diode.

The driver can, in particular, be a synchronous driver. In some developments of the lighting device, a synchronous driver for controlling two or more lighting paths may be provided. Compared to lighting devices with multiple lighting paths, which are controlled by several separate driver modules, a design with a synchronous driver has several advantages: In particular, different time-of-flight delays of the control circuits can be avoided. The synchronous driver may have a switch, e.g., a semiconductor switch, which switches several outputs of the driver synchronously. The semiconductor switch can, for example, include at least one MOSFET.

Alternatively, the synchronous driver may, for example, comprise several semiconductor switches which are controlled synchronously. In such embodiments, where the driver comprises several MOSFET switches, a symmetrical control of the gates can be provided-for example, by means of a common gate driver.

Furthermore, it may be provided that the synchronous driver include MOSFET switches whose switching times are coordinated. For example, the switching times can have a maximum variance of less than 500 ps, in particular less than 200 ps. Furthermore, it is preferred that the modulator be controlled by a differential signal for synchronous modulation of the driver. The modulator is preferably electrically connected to the driver via an LVDS (low voltage differential signaling) interface. Control via a differential signal, e.g., via an LVDS interface, has the advantage that the signal deviation between a low level and a high level is comparatively small, thereby minimizing electromagnetic interference fields and enabling a high frequency of the modulation signal.

For example, one output of the power source is connected in series to the light sources of the respective lighting path via the choke circuits. The power source can be operated in a current-controlled manner-for example, by means of a PID controller (proportional-integral-derivative controller). Alternatively, any other combination of the P, I, and D elements, or another control method, is also possible.

In some alternative designs of the lighting device, a separate power source is provided for each of the lighting paths. In this case, one output of each power source can be connected in series to the light sources of the relevant lighting path via the respective choke circuit.

The power source can advantageously be operated as a pulsed DC power source. For example, a pulse length can range from a few us to a few ms.

The modulator can, for example, impose a modulation frequency f2 in the range of 10 MHz to 100 MHz.

Furthermore, a time-of-flight camera is specified with a lighting device mentioned above and with a photodetector, wherein the time-of-flight camera is configured to emit light by means of the lighting device into an illumination region and to detect received light reflected from an object or person by means of the photodetector in order to determine a time of flight. The time-of-flight camera is in particular designed to monitor the radiation energy of the transmitted light by means of the first safety circuit and to switch off the output current Iₒᵤₜ(t) flowing through the light sources when the radiation energy exceeds a radiation energy threshold. Exceeding the radiation energy threshold can be detected in particular by the output current Iₒᵤₜ(t). The time-of-flight camera and the lighting device can be arranged in the same housing unit or designed as separate units.

Furthermore, a method is provided for operating a time-of-flight camera with a lighting device comprising at least one lighting path with at least one light source each, as well as with at least one power source and a modulator, wherein the time-of-flight camera is operated such that the at least one power source at an input of each lighting path provides an input current Iᵢₙ(t) which is modulated with a first frequency f₁, wherein the input current Iᵢₙ(t) for control of the light sources by means of the modulator is modulated with a second frequency f₂, wherein f₂>f₁, and wherein

an output current Iₒᵤₜ(t) flowing through the light sources is monitored by means of the safety circuit, wherein
a first mean current I_{avg,1} of the output current Iₒᵤₜ(t) is detected, which corresponds to an average of the output current Iₒᵤₜ(t) over a first time interval Δt1,
a second mean current I_{avg,2} of the current I(t) is detected, which corresponds to an average of the output current Iₒᵤₜ(t) over a second time interval Δt2, and
a third mean current I_{avg,3} of the current I(t) is detected, which corresponds to an average of the output current Iₒᵤₜ(t) over a third time interval Δt3; with Δt3>Δt2>Δt1; and wherein
the first mean current I_{avg,1} is compared with a first current threshold I_{max,1},
the second mean current I_{avg,2} is compared with a second current threshold I_{max,2}, and
the third mean current I_{avg,3} is compared with a third current threshold I_{max,3}; and
   wherein the output current Iₒᵤₜ(t) through the light sources (5) is switched off when the comparison shows that the first mean current I_{avg,1}, the second mean current I_{avg,2}, or the third mean current I_{avg,3} exceeds the respective current threshold.

In another aspect, the invention relates to a time-of-flight camera mentioned above, which is operated according to a method described above.

In the drawings:

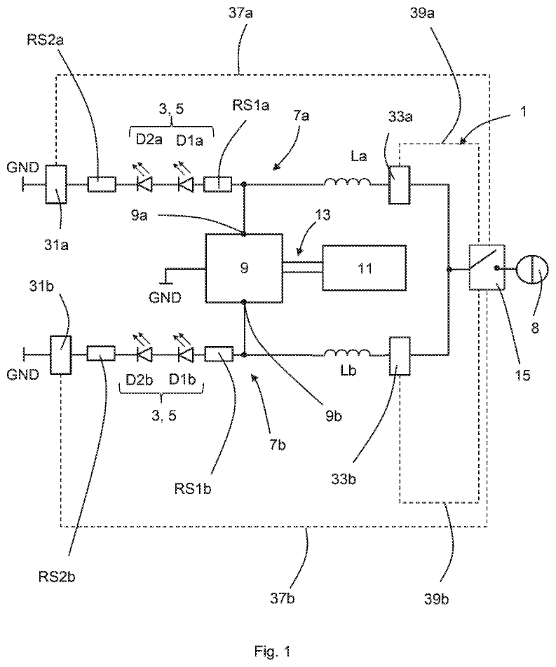

FIG. 1 shows a schematic representation of an exemplary embodiment of a lighting device according to the invention;

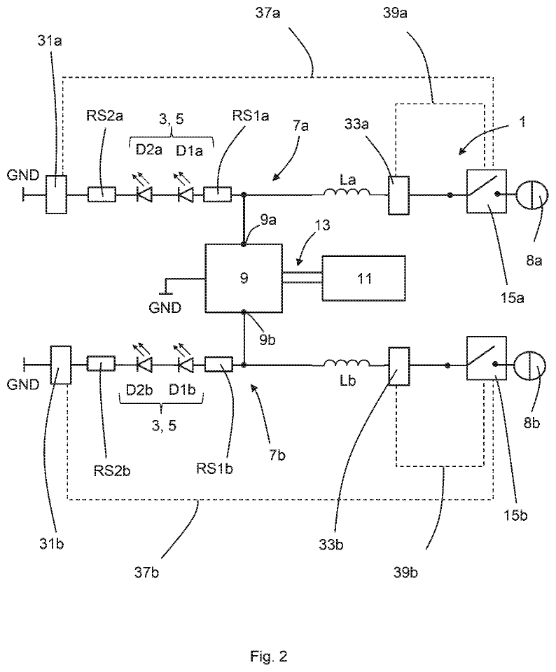

FIG. 2 shows a schematic representation of a further exemplary embodiment of a lighting device according to the invention with separate power sources;

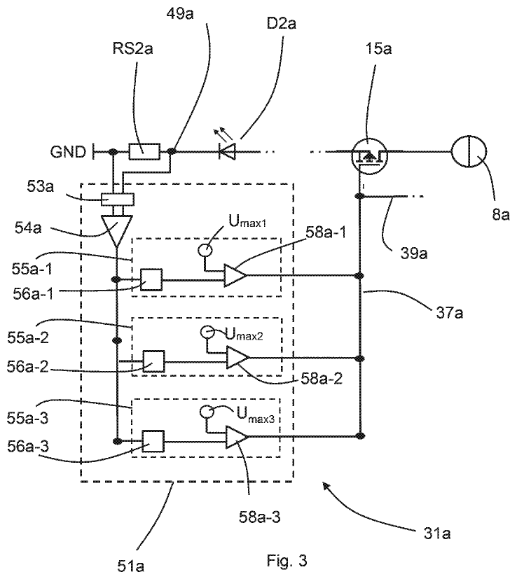

FIG. 3 shows a schematic representation of the first safety circuit;

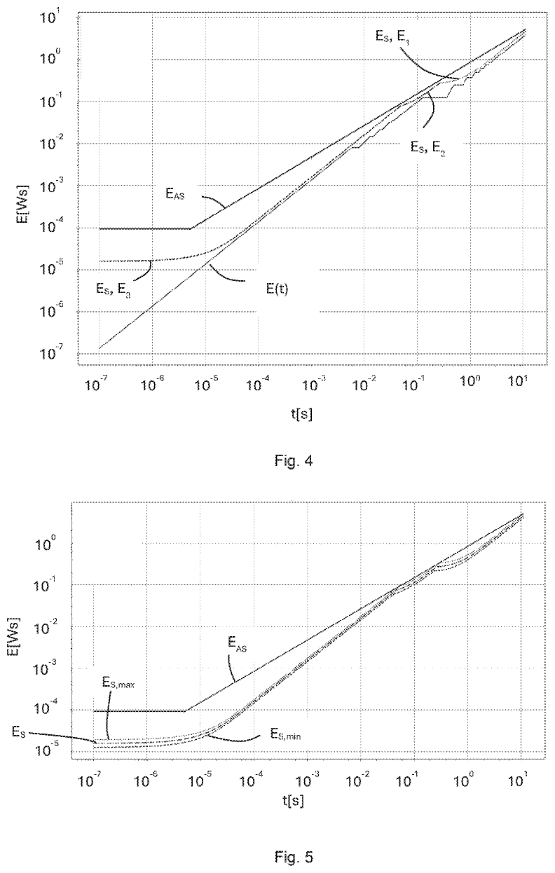

FIG. 4 shows the course of a radiation energy threshold value as a function of time;

FIG. 5 shows variations in the course of a radiation energy threshold value as a function of time;

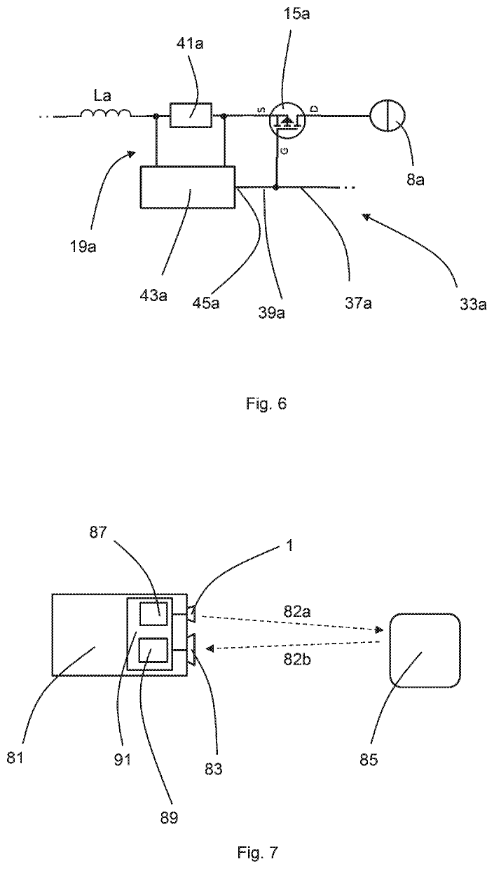

FIG. 6 shows a schematic representation of the second safety circuit;

FIG. 7 shows a time-of-flight camera system with a lighting device; and

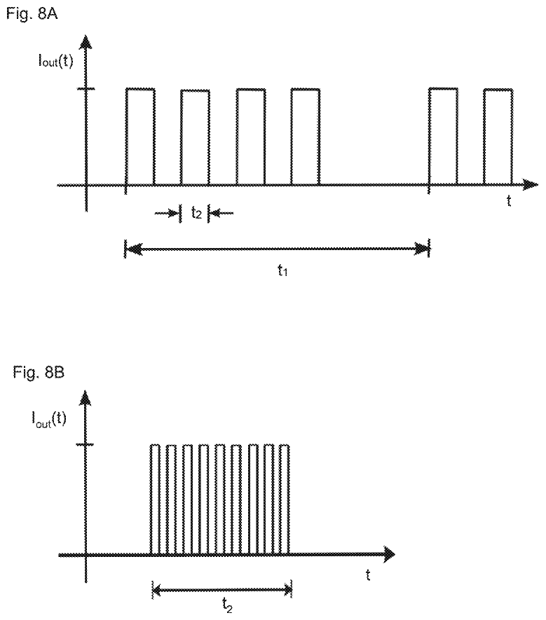

FIG. 8 shows a modulation of the output current Iₒᵤₜ(t) of the lighting device as a function of time t, during a distance measurement using a time-of-flight camera.

In the following description of the preferred embodiments, the same reference signs denote the same or comparable components.

FIG. 1 shows a schematic representation of an exemplary embodiment of a lighting device 1 with a light transmitter unit 3. In the example, the light transmitter unit 3 comprises several light sources 5, with two light sources 5 arranged in a first lighting path 7a and two light sources 5 in a second lighting path 7b. The light sources 5 are designed as laser diodes in the example. Two laser diodes D1a and D2a thus form the light sources 5 of the first lighting path, while two laser diodes D1b and D2b form the light sources 5 of the second lighting path. The laser diodes D1a to D2b can each be implemented as a VCSEL array. Alternatively, light-emitting diodes, for example, can also be used as light sources.

For power supply, the two lighting paths 7a, 7b are connected to a power source 8, which, for example, provides a modulated DC power source. For example, the power source can provide a pulsed direct current with a pulse length in the range of a few us to a few ms.

A synchronous driver 9 is provided for controlling the light sources 5 and is designed to control the light sources 5 of the first lighting path 7a and those of the second lighting path 7b synchronously. To imprint a high-frequency modulation, the lighting device 1 further comprises a modulator 11. For this purpose, the modulator 11 is electrically connected to the driver 9. The modulation signal can, for example, have a modulation frequency f2 in the MHZ range. For example, a modulation frequency f2 in the range of 5 MHZ≤f2≤200 MHz can be provided to control the VCSEL d1a to d2b.

In particular, it may be provided that the modulator 11 provide a differential modulation signal to the driver 9. In the example, the modulator 11 and the driver 9 are coupled via an LVDS interface 13. Thus, high-frequency modulation of the signal output by the driver 9 at the light sources 5 can be carried out. In particular, this can also minimize electromagnetic interference fields and enable rapid rises in the signal's edges.

Furthermore, a choke circuit is arranged in each of the lighting paths 7a, 7b. The choke circuits each include at least one inductor La, Lb. This allows parasitic inductances for each of the lighting paths 7a, 7b to be compensated for. Furthermore, the inductor of the chokes ensures that the edges of the high-frequency modulated signal rise quickly. For example, the VCSEL's d1a to d2b can each have a forward voltage of approximately 1 V to 4 V. With two VCSEL's connected in series, a voltage of 2 V to 8 V is present at the input of the two light sources d1a, d2a or d1b, d2b. At an edge change, the choke can then drive the VCSEL current and, depending upon parasitic inductances and capacitances, cause a rapid voltage rise to, for example, 5 V to 16 V, so that the laser threshold of the VCSEL is quickly reached, and light is emitted. For example, the light sources 5 can be operated with a mean current strength in the range of 0.3 A to 3 A—for example, with approximately 0.5 A. The current peaks, especially during the rising edges, can then, for example, have a current strength in the range of 1 A to 6 A—for example, approximately 1.5 A.

The synchronous driver 9 is electrically connected symmetrically to the two lighting paths 7a, 7b. A first driver output 9a is connected to the first lighting path 7a, and a second driver output 9b is connected to the second lighting path 7b. It is advantageous if the lengths of the signal lines between the respective driver output 9a, 9b and the respective lighting path 7a, 7b are the same. In particular, it is advantageous if the total lengths of the signal line from the driver output to an input of the light sources 5 of the respective lighting paths 7a, 7b are the same.

In order to provide a synchronous signal to both lighting paths 7a, 7b, the driver 9 can, for example, include a semiconductor switch which synchronously switches the first driver output 9a and the second driver output 9b. For example, the driver 9 can include a MOSFET switch which provides the modulation signal at the first driver output 9a and at the second driver output 9b.

Alternatively, the driver 9 may include two or more synchronously operated semiconductor switches. For example, the driver 9 can include at least two synchronously operated MOSFET switches. The MOSFET switches can be controlled, in particular, via a common gate driver. Furthermore, the semiconductor switches, e.g., the aforementioned MOSFET switches, can be matched to each other-for example, selected with respect to their switching times. Thus, an almost identical signal time of flight of the control signal for operating the light sources at the driver outputs 9a, 9b or at the two lighting paths 7a and 7b can be provided. In the example, two light sources 5 connected in series are shown for each lighting path 7a, 7b. This can, for example, represent a good compromise with respect to the available installation space, the amount of light emitted, and the phase shift resulting from the different signal times of flight of the series connection. However, the driver does not have to be a synchronous driver; so, other configurations are also possible.

Furthermore, each of the lighting paths includes a first balancing resistor RS1a, RS1b, which is arranged at an input of the light sources 5. The first balancing resistor RS1a, RS1b can in particular be connected in series between the light sources 5 and the respective driver output 9a, 9b. A second balancing resistor RS2a, RS2b is arranged at one output of each of the light sources 5. The second balancing resistor RS2a, RS2b can in each case be connected in series between the light sources 5 and ground GND.

The balancing resistors R1a to R2b can each comprise a resistor circuit. In particular, it is advantageous to design the balancing resistors R1a to R2b in each case as a parallel circuit of two or more resistors, which can reduce the power loss of the circuit.

FIG. 2 shows an alternative embodiment of the lighting device from FIG. 1, wherein, here, a separate power source 8a, 8b is provided for each lighting path 7a, 7b. The power source 8a of the first lighting path 7a is connected via the first choke La to the input of the VCSEL d1a and d2a. Similarly, the second power source 8b for supplying the second lighting path 7b is connected via the second inductor Lb to the input of the VCSEL d1b, d2b. Two parallel power sources 8a, 8b have the advantage that the current is not divided via tolerance-prone series resistors and the VCSEL. Rather, the power sources 8a, 8b then provide each lighting path 7a, 7b with a defined input current Iᵢₙ(t). In some configurations, it may be advantageous to operate the different lighting paths 7a, 7b synchronously with different currents or current intensities.

The lighting devices 1 of FIGS. 1 and 2 further comprise, for each lighting path, a first safety circuit 31a, 31b and an optional second safety circuit 33a, 33b. The safety circuits 31a, 31b, 33a, and 33b can be designed in particular as eye safety circuits. The first safety circuits 31a, 31b are each arranged between the light sources 5 and ground GND. In the first lighting path 7a, for example, the safety circuit 31a is arranged between the cathode of the VCSEL d2a and ground GND.

FIG. 3 shows a schematic representation of an exemplary embodiment of the first safety circuit 31a of the lighting path 7a from FIG. 2. The components of the lighting path 7a are shown in the region of the power source 8a and in the region of the safety circuit 31a. The other components are not shown for clarity.

A measuring circuit 51a of the second safety circuit 33a is arranged at an output 49a of the light sources 5. In the example, the measuring circuit 51a is designed to detect a differential voltage across the balancing resistor RS2a. A first voltage tap contacts the first lighting path 7a between the cathode of the VCSEL D2a and the balancing resistor RS2a. A second voltage tap is formed between ground GND and the balancing resistor RS2a. The measuring circuit 51a can thus indirectly determine the output current Iₒᵤₜ(t) applied to the output 49a. In particular, the voltages tapped across the balancing resistor RS2a can be fed to a differential amplifier 54a. An input filter 53a, designed as a low-pass filter, is arranged in front of the differential amplifier 54a for filtering high-frequency interference signals. In the example, one output of the differential amplifier 54a is connected to three parallel-connected filter circuits 55a-1 to 55a-3. The filter circuit 55a-1 comprises a first low-pass filter 56a-1 with a first cutoff frequency f_{G1}; the second filter circuit 55a-2 comprises a second low-pass filter 56a-2 with a second cutoff frequency f_{G2}; and the third filter circuit 55a-3 comprises a third low-pass filter with a third cutoff frequency f_{G3}. The low-pass filter of the input filter advantageously has a cutoff frequency f_{G4} with f_{G4}>>f_{G1}, f_{G2}, f_{G3}. Especially advantageous is f_{G1}>f_{G2}>f_{G3}. For example, the first low-pass filter 56a-1 can be a first-order or second-order low-pass filter, the second low-pass filter 56a-2 can be a first-order or second-order low-pass filter, and the third low-pass filter 56a-3 can be a second-order, third-order, or higher-order low-pass filter. To set a uniform course of the radiation power threshold E_{S}(t) over time, it may be advantageous to choose the order of the second low-pass filter 56a-2 to be greater than or equal to the order of the first low-pass filter 56a-1. It can also be advantageous for the order of the third low-pass filter 56a-3 to be greater than or equal to the order of the second low-pass filter 56a-2. In principle, the three low-pass filters 56a-1 to 56a-3 can each be of any order. However, the examples listed may be advantageous in some applications for achieving a continuous and monotonic course of the radiation power threshold E_{S}(t) defined in this way.

One output of the first low-pass filter 56a is connected to a first voltage comparator 58a-1, one output of the second low-pass filter 56a-2 to a second voltage comparator 58a-2, and one output of the third low-pass filter to a third voltage comparator 58a-3. A first voltage threshold Uₘₐₓ₁ is applied as a reference to one input of the first voltage comparator 56a-1. Similarly, a second voltage threshold Uₘₐₓ₂ is applied to one input of the second voltage comparator 58a-2, and a third voltage threshold Uₘₐₓ₃ is applied to an input of the third voltage comparator 58a-3.

Using the voltage comparators 58a-1 to 58a-3, the measured mean voltages U_{avg1}, U_{avg2}, and U_{avg3} can now be compared with the respective voltage threshold Uₘₐₓ₁, Uₘₐₓ₂, or Uₘₐₓ₃. If the first mean voltage U_{avg1} exceeds the first voltage threshold Uₘₐₓ₁, this can indicate that the first current threshold I_{max,1} has been exceeded, If the second mean voltage U_{avg2} exceeds the second voltage threshold Uₘₐₓ₂, this can indicate that the second current threshold I_{max,2} has been exceeded. If the third mean voltage U_{avg3} exceeds the third voltage threshold Uₘₐₓ₃, this can indicate that the third current threshold I_{max,3} has been exceeded.

The three low-pass filters are designed so that each effectively measures the output current Iₒᵤₜ(t) over time. The output current is averaged over different time periods: The first low-pass filter 56a-1 is designed for detecting an output current I_{avg,1} averaged over the first time interval Δt₁, the second low-pass filter 56a-2 for detecting an output current I_{avg,2} averaged over the second time interval Δt₂, and the third low-pass filter 56a-3 for detecting an output current I_{avg,3} averaged over the third time interval Δt₃, with Δt₃>Δt₂>Δt₁. The third time interval Δt₃ can, for example, comprise 10⁻¹ s to approximately 15 seconds. The second time period can, for example, comprise 10⁻² s up to 5 s. The first time interval Δt₁ is chosen to be in particular short enough that peaks of the output current Iₒᵤₜ(t), e.g., due to a short circuit or other malfunction of the lighting device, can be detected early. The first time interval Δt₁ can, for example, comprise 10⁻⁷ s to 0.1 s.

An output of the first comparator 58a-1, the second comparator 58a-2, and the third comparator 58a-3 is in each case connected to a control input of the switch 15a. The switch 15a is designed for example as a self-blocking, p-channel MOSFET switch. In particular, after one of the threshold values has been exceeded, the switch 15a can be controlled via the control line 39a to disconnect the light sources 5 from the power source 8a. A design as a self-locking switch is generally advantageous. This ensures that eye safety is guaranteed even in the event of a failure of the first safety circuits 31a, 31b.

In addition to the control line 39a, the optional control line 37a is also indicated here, which can transmit a signal from a current peak monitoring of the optional second safety circuit 33a (cf. FIGS. 1, 2, and 6). This allows for redundancy in power monitoring, or in the monitoring of radiation energy.

FIG. 4 schematically shows the course of a typical threshold value E_{AS} (limit of accessible radiation) of the radiation energy E according to a common eye safety standard as a function of time t. Furthermore, an exemplary time course of a radiation energy threshold E_{S}(t) of the first safety circuit 31a, 31b is shown. The radiation energy threshold E_{S}(t) specifies a maximum permissible value for the radiation emitted by the light sources 5 as a function of time t. Furthermore, a simulated course of a radiation energy E(t) (energy of accessible radiation) detected by the first safety circuit 31a, 31b is shown, which is proportional to an output current Iₒᵤₜ(t) flowing through the light sources 5. The course of the radiation energy threshold E_{S} is formed of a first portion E₁ (corresponding to a first radiation energy threshold), a second portion E₂ (corresponding to a second radiation energy threshold), as well as a third portion E₃ (corresponding to a third radiation energy threshold). Exceedance of the first portion E₁ can be detected using the first low-pass filter 56a-1 of the first safety circuit 31a. Exceedance of the second portion E₂ can be detected using the second low-pass filter 56a-2 of the first safety circuit. Exceedance of the third portion E₁ can be detected using the third low-pass filter 56a-3 of the first safety circuit 31a. Thus, the radiation energy threshold E_{S}(t) can be defined over the relevant time/frequency range to meet the eye safety standard. In particular, it can be set such that the shutdown threshold is at a small but guaranteed distance from the threshold value E_{AS}, in accordance with the eye safety standard. Since the current thresholds I_{max,1} to I_{max,3} are each directly proportional to the radiation energy threshold E_{S}, the radiation energy E(t) can be monitored via the output current Iₒᵤₜ(t), and eye safety is ensured. The low-pass filters 56a-1 to 56a-3, or the comparators 58a-1 to 58a-3, are logically interconnected using an OR operation.

FIG. 5 also shows the course of the threshold values E_{AS} and E_{S}. Furthermore, variations of the threshold E_{S} due to deviations from the nominal values of the components used are shown. E_{S,min} shows a minimum course of the radiation energy threshold E_{S}, while E_{S,max} shows a maximum course of the threshold value E_{S}. The variations can be caused, for example, by component variation or external influences such as temperature, as well as by aging processes. As can be seen in FIG. 5, the deviations from the nominal values have only a minor effect on the threshold value E_{S}. Thus, the first safety circuit 31a, 31b can be designed such that the radiation energy threshold E_{S} is close to the threshold E_{AS} of the eye safety standard. Accordingly, the threshold values Iₘₐₓ₁, Iₘₐₓ₂, Iₘₐₓ₃, or corresponding voltage thresholds Uₘₐₓ₁, Uₘₐₓ₂, Uₘₐₓ₃ have to be subjected only to a comparatively small offset to account for the deviation of the components from their nominal values. This allows the lighting device to be operated at a comparatively high power, which can, for example, improve the signal-to-noise ratio of a time-of-flight camera.

FIG. 6 shows a cutout of FIG. 2 with an exemplary embodiment of the optional second safety circuit 33a of the first lighting path 7a. The optional second safety circuit 33b of the second lighting path 7b can be designed analogously. The inductor La, the power source 8a, the control line 37a, and an exemplary embodiment of the first safety circuit 31a are shown in schematic representation. The switch 15a is designed here as a self-blocking, p-channel MOSFET switch. The second safety circuit 33a also includes a shunt resistor 41a and a measuring circuit 43a. The input current Iᵢₙ(t) and/or the mean input current I_{in,avg} can be determined by means of the measuring circuit 43a via the voltage drop across the shunt resistor 41a. Finally, an output 45a of the measuring circuit 43 is connected, via the control line 37a, to a gate input of the switch 15a.

A time-of-flight camera system 81 with a time-of-flight camera 81, which comprises an embodiment of a lighting device 1 according to the invention and a photodetector 83, is shown schematically in FIG. 7. The lighting device 1 comprises a control circuit 87, on which, for example, a circuit corresponding to one of the preceding figures is formed and which can control the light transmitter unit 3 to emit transmitted light 82a. The transmitted light 82a can be reflected by an object 85 and, as received light 82b, hit the photodetector 83 of the time-of-flight camera 81 and be detected by it. For example, the photodetector 83 can include a PMD sensor for determining the time of flight of light. In the example, the photodetector 83 is coupled to a detector circuit 89. The detector circuit 89 and the control circuit 87 are arranged by way of example on a circuit board 91 of the time-of-flight camera 81.

As an alternative to indirect time-of-flight measurement using a PMD detector, the time-of-flight camera 81 can also be designed for direct measurement of the time of flight and can include a correspondingly designed photodetector 83.

FIG. 8 schematically illustrates the time course of the output current Iₒᵤₜ(t) through the light sources 5 of a lighting path 7a, 7b during a distance measurement using the time-of-flight camera 81. In this example, a distance measurement includes four phase measurements. The output current Iₒᵤₜ(t) is modulated with the frequency f1, so that a pulsed current with a pulse length t₂ is output by the driver 9, wherein a phase measurement is performed for each current pulse, as shown in FIG. 8a. The frequency f2 is imposed on the current pulses by means of the modulation signal, as shown in FIG. 8b as an example for one of the phase measurements from FIG. 8a. For example, the cutoff frequency f_{G3} of the third low-pass filter 56a-3 of frequency f1 and the cutoff frequency f_{G2} of the second low-pass filter 56a-2 of frequency f2 can now be adapted in the first safety circuit 33a. The cutoff frequency f_{G1} of the first low-pass filter 56a-1 can be set to a frequency f_{G1}>f_{G2}. The output current Iₒᵤₜ(t) can then be detected, averaged over different time scales, using the three low-pass filters 56a-1, 56a-2, and 56a-3, and eye safety can be ensured.

### LIST OF REFERENCE SIGNS

1 lighting device
3 light transmitter unit
5 light sources
7a first lighting path
7b second lighting path
8, 8a, 8b power source
9 driver
9a first driver output
9b second driver output
11 modulator
13 LVDS interface
15, 15a, 15b switch
31a, 31b first safety circuit
33a, 33b second safety circuit
37a, 37b control line
39a, 39b control line
41a shunt resistor

143a measuring circuit (of the second safety circuit 33a)
45a output of the measuring circuit 43a
49a output of the light sources
51a measuring circuit (of the first safety circuit 31a)

153a low-pass/input filter
54a differential amplifier
55a-1 first circuit part
55a-2 second circuit part
55a-3 third circuit part
56a-1 first low-pass filter
56a-2 second low-pass filter
56a-3 third low-pass filter
58a-1 first voltage comparator
58a-2 second voltage comparator
58a-3 third voltage comparator
81 time-of-flight camera
82a transmitted light
82b received light
83 photodetector
85 object
187 control circuit
89 detector circuit
91 circuit board
D1a, D2a light-emitting diodes
D1b, D2b light-emitting diodes
La, Lb inductor (choke)
Iᵢₙ(t) input current
I_{avg} mean current
Iₚₑₐₖ current maximum value
Iₒᵤₜ(t) output current
I_{avg, 1} first mean
I_{avg,2} second mean
I_{avg,3} third mean
I_{max,1} first current threshold
I_{max,2} second current threshold
I_{max,3} third current threshold
U_{avg1} first mean voltage
U_{avg2} second mean voltage
U_{avg3} third mean voltage
Uₘₐₓ₁ first voltage threshold
Uₘₐₓ₂ second voltage threshold
Uₘₐₓ₃ third voltage threshold
RS1a, RS2a balancing resistor
RS1b, RS2b balancing resistor

1. A lighting device for a time-of-flight camera system, with a light transmitter unit comprising at least one lighting path with at least one light source, and with at least one power source for providing an input current Iᵢₙ(t) at the at least one lighting path, and with a modulator for modulating an output current Iₒᵤₜ(t) flowing through the light sources, and with at least one first safety circuit which is arranged at an output of at least one lighting path and is designed to detect the output current Iₒᵤₜ(t) flowing through the light sources of the at least one lighting path, wherein the first safety circuit comprises at least three circuit parts, wherein
a first circuit part is designed to detect a first mean current I_{avg,1} and to compare it with a first current threshold I_{max,1}, wherein the first mean current I_{avg,1} corresponds to the output current Iₒᵤₜ(t) averaged over a first time interval Δt1,
a second circuit part is designed to detect a second mean current I_{avg,2} and to compare it with a second current threshold I_{max,2}, wherein the second mean current I_{avg,2} corresponds to the output current Iₒᵤₜ(t) averaged over a second time interval Δt2, and
a third circuit part is designed to detect a third mean current I_{avg,3} and to compare it with a third current threshold I_{max,3}, wherein the third mean current I_{avg,3} corresponds to the output current Iₒᵤₜ(t) averaged over a third time interval Δt3; wherein Δt3>Δt2>Δt1; and wherein
the first safety circuit is designed to switch off the output current Iₒᵤₜ(t) through the light sources when at least one of the current thresholds I_{max,1}, I_{max,2}, Or I_{max,3} is exceeded by the respective mean output current I_{avg,1}, I_{avg,2}, or I_{avg,3}.

2. The lighting device according to claim 1, wherein the first circuit part comprises a first low-pass filter and a first comparator the second circuit part comprises a second low-pass filter and a second comparator and the third circuit part comprises a third low-pass filter and a third comparator.

3. The lighting device according to claim 2, wherein an order of the third low-pass filter is greater than or equal to an order of the second low-pass filter and/or in that an order of the second low-pass filter is greater than or equal to an order of the first low-pass filter.

4. The lighting device according to claim 2, wherein the first low-pass filter has a first cutoff frequency f_{G1}, the second low-pass filter has a second cutoff frequency f_{G2}, and the third low-pass filter has a third cutoff frequency f_{G3}, wherein f_{G1}>f_{G2}>f_{G3}.

5. The lighting device according to claim 1, wherein the lighting device comprises at least two parallel lighting paths.

6. The lighting device according to claim 1, wherein each of the lighting paths comprises at least two light sources connected in series.

7. The lighting device according to claim 1, wherein each of the lighting paths comprises a second safety circuit which is configured to monitor the input current Iᵢₙ(t) of the respective lighting path, and wherein the second safety circuit is configured to switch off the output current Iₒᵤₜ(t) through the lighting paths when the input current Iᵢₙ(t) exceeds an input current threshold I_{in, max}.

8. The lighting device according to claim 1, wherein each of the lighting paths comprises at least one choke circuit with at least one inductor.

9. The lighting device according to claim 8, comprising a driver for controlling the light sources, wherein the driver has a driver output for each of the lighting paths, which is electrically connected to the respective lighting path between the choke circuit and the light sources of the respective lighting path.

10. The time-of-flight camera with the lighting device according to claim 1 and with a photodetector, wherein the time-of-flight camera is configured to emit transmitted light by means of the lighting device into an illumination region and to detect received light reflected from an object or a person by means of the photodetector in order to determine a time of flight, wherein the time-of-flight camera is configured to monitor the radiation energy of the transmitted light by means of the first safety circuit.

11. A method for operating a time-of-flight camera with a lighting device comprising at least one lighting path with at least one light source each, as well as with at least one power source and a modulator, wherein the time-of-flight camera is operated such that the at least one power source at an input of each lighting path provides an input current Iᵢₙ(t) which is modulated with a first frequency f₁, wherein the input current Iᵢₙ(t) for control of the light sources is modulated by means of the modulator with a second frequency f₂, and wherein f₂>f₁,
wherein an output current Iₒᵤₜ(t) flowing through the light sources monitored by means of a first safety circuit, wherein
a first mean current I_{avg,1} of the output current Iₒᵤₜ(t) is detected, which corresponds to an average of the output current Iₒᵤₜ(t) over a first time interval Δt1,
a second mean current I_{avg,2} of the current Iₒᵤₜ(t) is detected, which corresponds to an average of the output current Iₒᵤₜ(t) over a second time interval Δt2, and
a third mean current I_{avg,3} of the output current Iₒᵤₜ(t) is detected, which corresponds to an average of the output current Iₒᵤₜ(t) over a third time interval Δt3, with Δt3>Δt2>Δt1; and wherein
the first mean current I_{avg,1} is compared with a first current threshold I_{max,1},
the second mean current I_{avg,2} is compared with a second current threshold I_{max,2}, and
the third mean current I_{avg,3} is compared with a third current threshold I_{max,2}; and
wherein the output current Iₒᵤₜ(t) through the light sources is switched off when the comparison shows that the first mean current I_{avg,1}, the second mean current I_{avg,2}, or the third mean current I_{avg,3} exceeds the respective current threshold.

12. The a method according to claim 11, wherein the time-of-flight camera comprises a photodetector, wherein the time-of-flight camera is configured to emit transmitted light by means of the lighting device into an illumination region and to detect received light reflected from an object or a person by means of a photodetector in order to determine a time of flight, wherein the time-of-flight camera is configured to monitor a radiation energy of the transmitted light by means of a first safety circuit.
